(19) United States
(12) Patent Application Publication
(10) Pub. No.: US 2022/0303113 A1
(43) Pub. Date: Sep. 22, 2022

(54) INTERMEDIATE CODE ENCRYPTION METHOD BASED ON FULLY HOMOMORPHIC ENCRYPTION TECHNOLOGY AND CIPHERTEXT VIRTUAL MACHINE SYSTEM

(71) Applicants: Kewei ZHENG, Shanghai (CN); Hongda FAN, Shanghai (CN); Wenjun FU, Shanghai (CN)

(72) Inventors: Kewei ZHENG, Shanghai (CN); Hongda FAN, Shanghai (CN); Wenjun FU, Shanghai (CN)

(21) Appl. No.: 17/834,783

(22) Filed: Jun. 7, 2022

Related U.S. Application Data
(63) Continuation of application No. PCT/CN2020/138871, filed on Dec. 24, 2020.

(30) Foreign Application Priority Data
Dec. 26, 2019 (CN) 201911369162.1

(51) Int. Cl. H04L 9/00

(52) U.S. Cl. CPC H04L 9/008

(57) ABSTRACT

An intermediate code encryption method based on fully homomorphic encryption technology, and a ciphertext virtual machine system; instructions and data of an application in a virtual machine are fully homomorphically encrypted by improving a function key part, and output result ciphertext is obtained by performing ciphertext identification on input data and adopting corresponding homomorphic processing operations, so that running of the virtual machine in an encrypted environment is implemented; according to the present invention, an application is fully homomorphically encrypted, not only data in the program but also instructions of the program are encrypted, and thus, the program logic and structure are protected to the greatest extent.

### CROSS REFERENCES

This application is the continuation of application of International Application No. PCT/CN2020/138871 filed on 24 Dec. 2020 which designated the U.S. and claims priority to Chinese Application No. CN201911369162.1 filed on 26 Dec. 2019, the entire contents of each of which are hereby incorporated by reference.

### TECHNICAL FIELD

The invention relates to the technical field of information security, in particular to an intermediate code encryption method based on fully homomorphic encryption technology and a ciphertext virtual machine system, which are suitable for various kinds of virtual machines and high-level languages which use interpreter execution mode

### BACKGROUND OF THE INVENTION

In order to protect data, various encryption technology can be used. However, the protection of applications, in other word a program, is much more difficult and often requires complex methods to build a secure and trusted execution environment. It is common practice to encrypt the application, decrypt it in a specific CPU safe zone, and then execute it, ensuring that the data cache and memory space used for the program's execution is isolated from the outside world. This invention provides a method to execute encrypted applications without decryption, which can effectively simplify the construction scheme of trusted execution environment.

The existing high-level language can be categorized into two types of, compiled languages and interpreted languages, according to the execution mode. However, Java proposed the virtual machine method, which has successfully leveraged the advantages of both execution modes. Java application program is compiled into an intermediate code, which is loaded by the virtual machine program for local execution. The source code of the application program is protected in some extend as the intermediate code is already an complied version. however, since the standard of the intermediate code is open, reverse engineering methods can easily analyze the intermediate code and generate the effective source code. For some special application programs, such as a programe of quantitative trading, the program structs and process logics are very important and high-valued. Therefore the intermediate codes of these kinds of applications have risks to be cracked by reverse engineering. Another example is the public blockchain platform such as the Ethereum, the intermediate code of the smart contract can be easily obtained by anybody, anytime if the address is known. In addition, knowledge in the program in the form of constants, empirical values, parameters, and formulas also has serious leakage risk.

### SUMMARY OF THE INVENTION

In order to eliminating the risk of knowledge leakage inside the program, the invention provides an intermediate code encryption method based on a fully homomorphic encryption technology and a ciphertext virtual machine system. By encrypting the application program, which means not only the data, but also the instructions of the program are encrypted, so that the program logic and structure are completely protected. Since the fully homomorphic encryption technology supports any kinds of calculations and operations on the ciphertext, the encrypted program can still be correctly and efficiently processed by the virtual machine, meanwhile the input/output data of the program is also ciphertext.

The invention is implemented through the following technical scheme:

The invention relates to an intermediate code encryption method based on a fully homomorphic encryption technology. Based on the coefficient mapping transformation polynomial fully homomorphic encryption, an improvement on function key part is introduced to increase the cipher operation efficiency and accuracy. The instructions and data inside the intermediate code are fully homomorphic encrypted. By identifying the encrypted input data and using the corresponding homomorphic ciphertext operations, the virtual machine can correctly execute the encrypted intermediate code and obtain the output ciphertext data as the final result of the program.

The application program comprises, but is not limited to, a Java program

The improved function key portion refers to a function F in the key K=(f,n) is non-zero at any point. So F can be used as a denominator and it is ensured that there is no odd point.

The identification means that when the input data is not encrypted, the input data is encrypted by using the corresponding public key; when the ciphertext space of the encrypted input data is different from the program ciphertext space, the input data is rejected and an error is reported.

Before any encrypted program runs, the ciphertext space identifier is verified, and when the ciphertext space identifier is equal to the space identifier of the encrypted program, all the ciphertext inputs are valid.

The homomorphic ciphertext operation includes, but is not limited to, algebraic operations of decimal ciphertexts, logical operations and displacement operations of binary ciphertexts, number system conversion operations, ciphertext space conversion operations, and comparison operations.

The invention relates to a ciphertext virtual machine system based on a fully homomorphic encryption technology. The ciphertext virtual machine system comprises a code encryptor used for encrypting an intermediate code file to obtain encrypted intermediate code, wherein the ciphertext virtual machine executes the encrypted intermediate code according to the homomorphic ciphertext operation according to the type of program content.

### Technical Effect

Compared with the prior art, the basic form of the fully homomorphic encryption algorithm based on the coefficient mapping transformation polynomial on the real and binary integer is improved and innovated, the definition of the ciphertext is increased, the whole program is encrypted by using the complete homomorphic encryption technology, the data in the program is encrypted, the processing logic of the program and the operation instruction page are encrypted. When the encrypted program is executed, it does not need to be decrypted in the virtual machine, and the input/output data of the encrypted program is required to be ciphertext, during the whole execution progress all the data and program can always be kept in the ciphertext state.

### BRIEF DESCRIPTION OF THE DRAWINGS

FIG. 1 is a schematic architectural diagram of a ciphertext virtual machine system;

FIG. 2 is a schematic diagram of a binary ciphertext homomorphic comparison operation process;

FIG. 3 is a schematic diagram of a non-comparable space ciphertext homomorphic comparison operation process;

FIG. 4 is a schematic diagram of an intermediate code encryption process;

FIG. 5 is a schematic flow chart of a ciphertext virtual machine loading and initializing an encrypted Java language.Class intermediate code file;

### DETAILED DESCRIPTION OF THE EMBODIMENTS

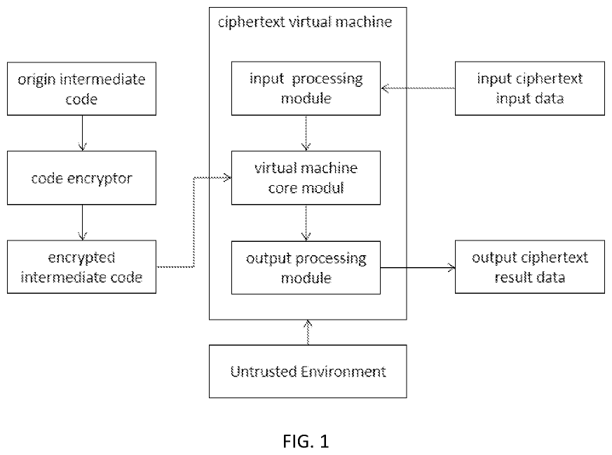

As shown in FIG. 1, the ciphertext virtual machine system of the present embodiment comprises: a code encryptor used for encrypting an intermediate code file to obtain an encrypted intermediate code, wherein the ciphertext virtual machine executes an encrypted intermediate code program according to the homomorphic ciphertext operation according to the type of the encrypted data.

The intermediate code file is compiled by the source code, which is compliant to standard specifications of virtual machines, and can be executed by a virtual machine.

According to the embodiment of the invention, the class file of the Java language is taken as an example, and the encryption method of the intermediate code is described. The Class file contains a Java virtual machine instruction set and a symbol table and several other auxiliary information. The method is not limited to encrypting the Java class file, and other virtual machine standards can also be processed in the same manner.

According to the standard of the Java virtual machine, the structure of the Class file comprises the following parts: magic number (Class file header identifier, 4 bytes), version number (secondary version number, 2 bytes); and the main version number is 2 bytes). A constant pool (a 2-byte length, constant types and values); a class access identifier (2 bytes); a class index (a class constant pool index, 2 bytes); a superclass index (a superclass constant pool index, 2 bytes); an interface index table (a 2-bytes length, an interface constant pool index list); a field list (a 2-byte length, a field table); a method list (a 2-byte length, a method table); an attribute list (a 2-byte length, an attribute table).

The content of the class file can be divided into three types:
(1) the identification/instruction/index type data, of which an efficient homomorphic comparison operation is required, and comprises: the magic number, the version number, the list length, the list index, the data type identifier, the name identifier, the operation instruction;
(2) the numeric type data, of which the homomorphic comparison operation does not need to be considered, and comprises: a constant value and an operand value which are mainly decimal data;
(3) In very few cases, the non-numeric type data, of which the homomorphic comparison operation is required, and comprises: the constant value, mainly binary data.

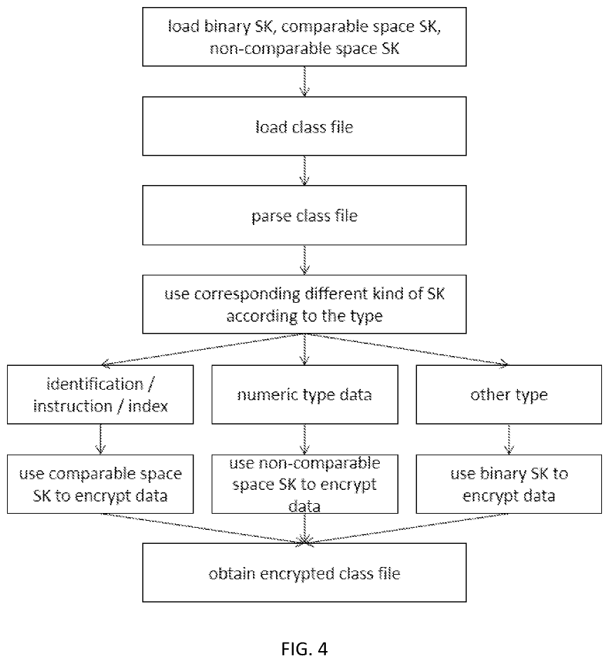

As shown in FIG. 4, the code encryptor loads the corresponding private key (denoted as SK below) of the three types of the class file of the Java language, that is, the binary SK corresponding to the non-numeric type data, the comparable space SK corresponding to the numeric type data, the non-comparable space SK corresponding to the identification/instruction/index data. The class file generated by the Java compiler is loaded, the system analyzes and reads the file content by byte, uses different encrypting strategies according to the content types, and finally obtains the encrypted class file.

The different strategies refer to the following steps: when the read content is an identifier, an instruction or an index, encrypting it by using a comparable space SK to obtain a comparable ciphertext; when the read content is numerical type data, encrypting it by using a non-comparable space SK to obtain a non-comparable ciphertext; and when the read content is non-numeric data, encrypting it by using a binary SK to obtain a binary ciphertext

Encrypting algorithm, ie, is polynomial fully homomorphic encryption, and the encryption formula is

$$P = {\sum }_{i} {a}_{i} \cdot f ( {x}_{i} ) \cdot {y}_{i} .$$

A coefficient vector a={aᵢ|iϵI} and a function key argument vector x={xᵢ|iϵI}, which constitute a data ciphertext c=(a, x); f( ) is a function key part, y={yᵢ|iϵI} is a polynomial key part, and the key is k={f( ), y}.

Preferably, the function key part F of the polynomial fully homomorphic encryption in the embodiment is a left continuous or right continuous piecewise function and meets the condition that the interval in the definitional domain can be differentiable, and meets ∀xϵD and f(x)≠0, that is, the function may always be located above the 0 axis within some portions of intervals, while in the other parts, it may always be below the 0 axis, and must not cross the 0 axis. Therefore, the F can be used as a denominator when calculating divide operation.

When the above form of function F is used as a key, the corresponding ciphertext space is a non-comparable space, that is, the ciphertext obtained by using this kind of SK cannot be subjected to homomorphic comparison operation.

As shown in FIG. 1, the ciphertext virtual machine comprises: an input processing module, a virtual machine core module and an output processing module, wherein the virtual machine core module and the output processing module are used for homomorphic ciphertext operation: the input module judges whether the input data ciphertext is encrypted and whether the ciphertext space is consistent with the ciphertext space corresponding to the whole application program, the virtual machine core module loads the encrypted intermediate code and obtains a main program inlet according to the method list, the instructions are executed one by one according to the instruction stack of the entry method, and the output processing module outputs and/or performs ciphertext space conversion on the output data according to the logic of the program, namely the operation requirement of the program formed by the instruction set stack; the encrypted instruction and the instruction operand are read in byte, and the instruction ciphertext is assembled according to the instruction length. Then, the specific corresponding instruction number is analyzed through a ciphertext comparison operation, and then the instruction is executed.

The homomorphic ciphertext operation comprises algebraic operations of a decimal ciphertext, logic operations and displacement operations of binary ciphertext, number system conversion operations, ciphertext space conversion operations, comparison operation.

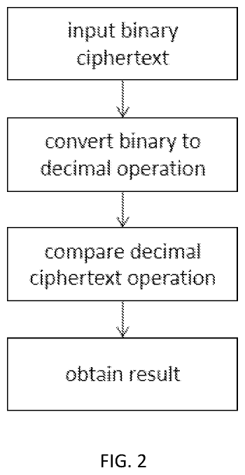

The comparison operation comprises a comparison operation of a binary ciphertext and a comparison operation of a non-comparable space ciphertext. The binary ciphertext can be converted into a comparable decimal ciphertext space as shown in FIG. 2, and then the homomorphic comparison operation is executed to obtain a comparison result

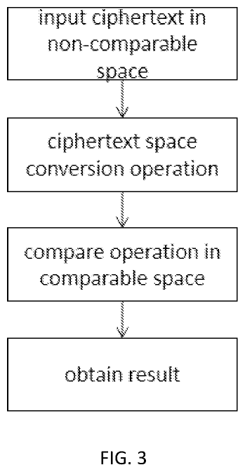

Similarly, for a ciphertext of a non-comparable space, a ciphertext space conversion operation as shown in FIG. 3 is needed, first turning to a comparable ciphertext space, and then performing homomorphic comparison operation to obtain the result.

The input processing module checks the input data, when it is not encrypted, the corresponding public key is used to encrypt the input data; when the space of the input ciphertext is different from the program data space, it will be rejected.

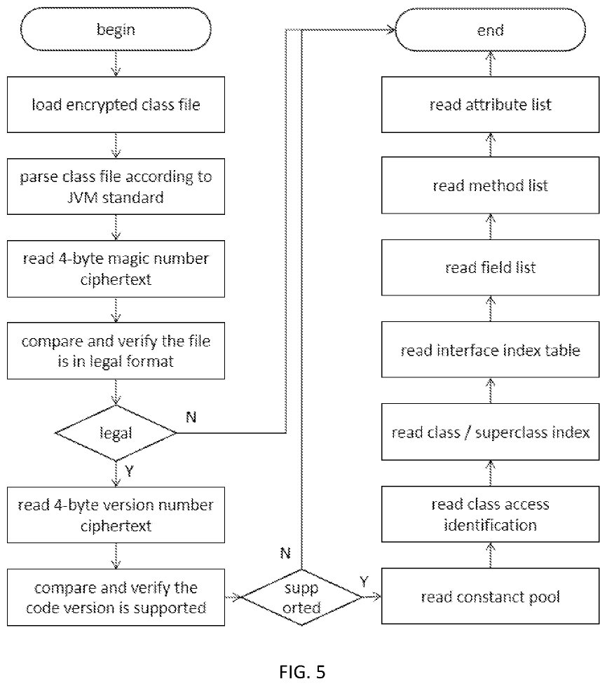

As shown in FIG. 5, the virtual machine core module loads an encrypted intermediate code, that is, firstly loading an encrypted Class intermediate code file into a virtual machine, creating a program and a constant memory space, the specific steps comprising:
A. loading an encrypted CLASS file;
B. reading class file content bytes one by one according to the class file structure in the JVM standard;
C. reading 4-byte magic number ciphertext;
D. compared with the class file magic number, verify the loaded encrypted class file is the correct type is judged. If it is correct, the next step is continued, otherwise the program is ended;
E. reading 4-byte version number ciphertext;
F. check version number is supported by the virtual machine or not, by using the homomorphic comparison operation, and if the version is correct, moving to the next step, otherwise, ending the program;
G. reading the length of the constant pool, which is a 2-byte ciphertext, and initializing the constant pool pointer to be 0; comparing whether the constant pool pointer is smaller than the length ciphertext or not, and when the constant pool pointer is smaller than the length ciphertext, reading a constant structure ciphertext, and adding the pointer to one; otherwise, ending the constant pool reading. The above process is repeated until the pointer is larger than the length ciphertext, by then the constants of all the constant pools are read and loaded;
H. reading class access identification ciphertext, and confirming accessibility through homomorphic comparison operation when the class is accessed by other classes;
I. reading class and superclass index ciphertext: creating a constant pool pointer, initializing to 0, comparing whether the pointer is smaller than an index ciphertext, and if the comparison pointer is smaller than the index ciphertext, reading the ciphertext of the constant pool at the current pointer position;
J. reading interface index list and the length processing method are as similar to that of step G; and the index processing method is as described in step I
K. reading field list, length and index processing method as described above;
L. read method list, length and index processing method as described above. Instruction ciphertext is involved here, which needs to be read according to the method structure of JVM standard;
M. reading attribute list, the length and the index processing method are as described above. And after this step, the entire encrypted Class intermediate code file is loaded and initialized

The virtual machine core module first reads an instruction ciphertext, uses homomorphic comparison operation, compares the instruction ciphertext with the instruction list one by one, acquires a corresponding specific operation instruction, and then reads a subsequent instruction operand ciphertext according to the definition of the instruction, and executes the instruction

When input and output operations are involved, the virtual machine core module calls the input processing module and the related functions of the output processing module to process data input and output.

According to the embodiment, the encrypted Java virtual machine is used as an example, a normal class file obtained by any Java compiler can be loaded and parsed, and then the encrypted class file is obtained by adopting different encrypting methods for different types of data.

The encrypted class file obtained by this method is safe and reliable, and can effectively prevent various cracking or reverse engineering from stealing the intellectual property rights in the Java program code itself. Such an encrypted class file can run in the ciphertext virtual machine according to the present invention, but the virtual machine must obtain the permission in advance, which means the operation dictionary must be accessible, so that the encrypted program can be executed correctly. When the encrypted program is executed in the ciphertext virtual machine, the input/output data is ciphertext. The most important difference from the other methods is that the intellectual property in the program is completely protected, and meanwhile, the program can be executed correctly. But the processing speed of the ciphertext operation are greater than the plaintext one, the program execution efficiency of the ciphertext virtual machine will be reduced comparing with the normal virtual machine.

The above-mentioned specific implementation can be locally adjusted by a person skilled in the art without departing from the principle and spirit of the present invention. The protection scope of the present invention is subject to the scope of the claims and is not limited by the specific embodiments described above, and various implementations within the scope thereof are constrained by the present invention.

What is claimed is:

1. The intermediate code encryption method based on the fully homomorphic encryption technology is characterized in that instructions and data of an application program in the virtual machine are encrypted by the coefficient mapping transformation polynomial fully homomorphic encryption with an improvement on function key part, ciphertext identification is carried out on the input data, and a corresponding homomorphic ciphertext operation is adopted to obtain the encrypted output result, so that the operation of the virtual machine in the ciphertext space is implemented; the identification means that when the input data is not encrypted, the input data is encrypted by using the corresponding public key; when the ciphertext space of the encrypted input data is different from the program ciphertext space, the input is rejected and an error is reported; and the ciphertext space identifier is verified before any encryption program runs, and when the ciphertext space identifier is equal to that of the application program, it is considered that all ciphertext inputs are valid; otherwise, all the operation results corresponding to the ciphertext data are error results; and encryption formula of the polynomial fully homomorphic encryption is
$$P = {\sum }_{i} {a}_{i} \cdot f ( {x}_{i} ) \cdot {y}_{i} ;$$
a coefficient vector a={aᵢ|iϵI} and a function key argument vector x={xᵢ|iϵI}, which constitute a data ciphertext c=(a, x); f( ) is a function key part, y={yᵢ|iϵI} is a polynomial key part, and the key is k={f( ), y}.

2. The intermediate code encryption method based on the fully homomorphic encryption technology according to claim 1, wherein the improvement function key part refers to that the function key part F in the key k={f( ), y} does not equal to zero, so that the function key part F can be used as a denominator.

3. The intermediate code encryption method based on the fully homomorphic encryption technology according to claim 1, wherein the homomorphic ciphertext operation comprises algebraic operations of decimal ciphertexts, logical operations and displacement operations of binary ciphertexts, number system conversion operations, ciphertext space conversion operations, and comparison operations.

4. The ciphertext virtual machine system based on the fully homomorphic encryption technology is characterized by comprising a code encryptor used for encrypting an intermediate code file to obtain an encrypted intermediate code, wherein the ciphertext virtual machine executes an intermediate code program according to the homomorphic ciphertext operation, and performs homomorphic comparison operation according to the type of the program content; and the ciphertext virtual machine comprises an input processing module, a virtual machine core module used for homomorphic ciphertext operation and an output processing module, wherein the input module judges whether the input data is encrypted and whether the ciphertext space of the input data is equal to the ciphertext space of the application program or not, the virtual machine core module loads the encrypted intermediate code and obtains a main program inlet according to the method list, and instructions are executed one by one according to the instruction stack of the inlet method; the output processing module performs ciphertext space conversion on the output data according to the logic of the program, the encrypted instruction and the instruction operand are read in byte, the instruction ciphertext is assembled according to the instruction length, the specific corresponding instruction number is analyzed according to the JVM instruction standard, and then the instruction is executed.

5. The ciphertext virtual machine system according to claim 4, wherein the different policies refer to: if the read content is an identifier, an instruction, or an index, it is encrypted by using a comparable space SK to obtain a comparable ciphertext; if the read content is numerical type data, it is encrypted by using a non-comparable space SK to obtain a non-comparable ciphertext; and when the read content is non-numeric data, it is encrypted by using a binary private key to obtain a binary ciphertext.

6. The ciphertext virtual machine system according to claim 4, wherein the code encryptor loads three types of corresponding private keys (SK), that is, the binary SK corresponding to the non-numeric type data, the comparable space SK corresponding to the numeric type data, the non-comparable space SK corresponding to the identification/instruction/index data; the class file generated by the Java compiler is loaded, the system analyzes and reads the file content by byte, uses different encrypting strategies according to the content types, and finally obtains the encrypted class file.

7. The ciphertext virtual machine system according to claim 4, wherein the input module determines that when the input data is not encrypted, the input data is encrypted by using the corresponding public key; when the ciphertxt space of the input ciphertext is different from the program ciphertext space, the input data is rejected.

8. The ciphertext virtual machine system according to claim 4, wherein the virtual machine core module first reads the instruction ciphertext, uses the homomorphic comparison operation, compares the instruction ciphertext with the instruction list one by one, and acquires a corresponding specific operation instruction; and then reads the subsequent instruction operand ciphertext according to the definition of the specific instruction, and executes the instruction.

9. The ciphertext virtual machine system according to claim 4, wherein the virtual machine core module loads an encrypted intermediate code, that is, firstly loading an encrypted Class intermediate code file into a virtual machine, creating a program and a constant memory space, and the specific steps comprise: A) finding and reading an encrypted CLASS file; B) reading class file contents one by one according to the class file structure in the JVM standard; C) reading the 4-byte magic number ciphertext; D) comparing with the class file magic number by using the homomorphic comparison operation, and judging whether the loaded encrypted class file is the correct type or not; if yes, continuing the next step, otherwise, ending the initialization; E) reading the 4-byte version number ciphertext; and F) By using the homomorphic comparison operation, the check version number is supported by the virtual machine or not, and when the version is correct, proceeds to the next step, otherwise, the program is ended; and G) reading the length of the constant pool, which is a 2-byte ciphertext, and initializing the constant pool pointer to be 0; comparing whether the constant pool pointer is smaller than the length ciphertext, if yes, reading a constant structure ciphertext, and adding one onto the pointer; repeating the process until the pointer is larger than the length ciphertext, wherein the whole constant pools are read and loaded; H) reading a class access identification ciphertext, and confirming accessibility through homomorphic comparison operation when the class is accessed by other classes; and I) Reading class and superclass index ciphertext: creating a constant pool pointer, initializing to 0, comparing whether the pointer is smaller than the index ciphertext, and if the comparison pointer is smaller than the index, reading the ciphertext of the constant pool at the current pointer position, wherein the class definition and the superclass definition are all in the constant pool; J) reading interface index list and the length processing method are as described in the step G; the index processing method is as described in the step I; K) reading field list, the length and the index processing method are as described above; L) reading method list, the length and the index processing method are as described above and the instruction need to be read according to the JVM standard; and M) reading attribute list, the length and the index processing method are as described above, and the entire encrypted Class intermediate code file is loaded and initialized.

10. The ciphertext virtual machine system according to claim 8, wherein the virtual machine core module loads an encrypted intermediate code, that is, firstly loading an encrypted Class intermediate code file into a virtual machine, creating a program and a constant memory space, and the specific steps comprise: A) finding and reading an encrypted CLASS file; B) reading class file contents one by one according to the class file structure in the JVM standard; C) reading the 4-byte magic number ciphertext; D) comparing with the class file magic number by using the homomorphic comparison operation, and judging whether the loaded encrypted class file is the correct type or not; if yes, continuing the next step, otherwise, ending the initialization; E) reading the 4-byte version number ciphertext; and F) By using the homomorphic comparison operation, the check version number is supported by the virtual machine or not, and when the version is correct, proceeds to the next step, otherwise, the program is ended; and G) reading the length of the constant pool, which is a 2-byte ciphertext, and initializing the constant pool pointer to be 0; comparing whether the constant pool pointer is smaller than the length ciphertext, if yes, reading a constant structure ciphertext, and adding one onto the pointer; repeating the process until the pointer is larger than the length ciphertext, wherein the whole constant pools are read and loaded; H) reading a class access identification ciphertext, and confirming accessibility through homomorphic comparison operation when the class is accessed by other classes; and I) Reading class and superclass index ciphertext: creating a constant pool pointer, initializing to 0, comparing whether the pointer is smaller than the index ciphertext, and if the comparison pointer is smaller than the index, reading the ciphertext of the constant pool at the current pointer position, wherein the class definition and the superclass definition are all in the constant pool; J) reading interface index list and the length processing method are as described in the step G; the index processing method is as described in the step I; K) reading field list, the length and the index processing method are as described above; L) reading method list, the length and the index processing method are as described above and the instruction need to be read according to the JVM standard; and M) reading attribute list, the length and the index processing method are as described above, and the entire encrypted Class intermediate code file is loaded and initialized.
